(19) United States
(12) Patent Application Publication
(10) Pub. No.: US 2005/0226159 A1
(43) Pub. Date: Oct. 13, 2005

(54) Apparatus, and associated method, for providing a medium access control layer hybrid automatic repeat request scheme for a carrier sense multiple access communication scheme

(76) Inventors: John Terry, Garland, TX (US); Matthew Shoemake, Allen, TX (US)

Correspondence Address: SCHEEF & STONE, L.L.P., 5956 SHERRY LANE, SUITE 1400, DALLAS, TX, 75225, US

(21) Appl. No.: 11/101,291

(22) Filed: Apr. 7, 2005

Related U.S. Application Data
(60) Provisional application No. 60/561,561, filed on Apr. 13, 2004.

(51) Int. Cl. H04Q 7/00

(52) U.S. Cl. 370/236

(57) ABSTRACT

Apparatus, and an associated method, for providing a hybrid automatic repeat request (H-ARQ) scheme for the Medium Access Control Layer of an IEEE 802.11n-compliant wireless local area network system, or other carrier sense multiple access communication system. When a packet delivered to a destination station is unable successfully to be decoded, a negative acknowledgement message is generated and returned to a sending station to identify the failed decoding. Selection is made at the sending station to send information, such as pursuant to a soft combining scheme are pursuant to an incremental redundancy scheme. A detector and selector embodied at the destination station detects whether the packet has been successfully delivered to the destination station and selects in what manner to respond to the sending station in response thereto.

### CROSS REFERENCE TO RELATED APPLICATIONS

The present invention claims the priority of provisional patent application 60/561,561 filed on Apr. 13, 2004, the contents of which are incorporated by their entirety herein.

The present invention relates generally to an automatic repeat request (ARQ) scheme for a packet radio communication system, such as a wireless local area network (WLAN) operable pursuant to a variant of an IEEE 802.11 operating protocol, or other Carrier Sense Multiple Access (CSMA) network. More particularly, the present invention relates to apparatus, and an associated method, that provides a hybrid ARQ/LA technique for a CSMA network, such as at the MAC layer of an 802.11n complaint-WLAN system.

The hybrid ARQ scheme provides for the generation, at a destination station, of a MAC layer, negative acknowledgement (NAK) to indicate that the destination station is unable successfully to decode a received packet as well as a positive acknowledgement (ACK) to indicate successful delivery of the packet. Improved communication system performance is provided through the capability of sending negative acknowledgements at the MAC layer. By earlier identifying to a transmitting station the unsuccessful decoding of a received packet at the destination station, additional operation of the transmitting station to cause successful communication of the packet is carried out.

### BACKGROUND OF THE INVENTION

Advancements in communication technologies have permitted the development, deployment, and popular usage of many varied types of communication systems. In a communication system, data is communicated between communication stations of a set of communication stations. The set of communication stations includes at least one sending station and at least one receiving station. A communication channel interconnects the communication stations that are parties to a communication session in which the data is communicated. Data sourced at a sending station is caused to be communicated by the sending station upon the communication channel. A receiving station detects the data communicated upon the communication channel and operates to recover the informational content of the data, once delivered to the receiving station.

A radio communication system is a communication system in which the communication channel that interconnects the sending and receiving stations is formed of a radio communication channel. A radio communication channel is defined upon a portion of the electromagnetic spectrum. When data is communicated upon a radio channel of a radio communication system, the data is communicated between the sending and receiving stations without any physical connection between the sending and receiving stations. That is to say, in contrast to a wireline communication system, a radio communication system operates free of the need of a wireline connection between the sending and receiving stations. The communication stations of a radio communication system, as a result, are positionable at locations between which wireline connections would be unavailable while still permitting communications to be effectuated between the sending and receiving stations. A radio communication system is also implementable as a mobile communication system in which one or more of the communication stations are permitted mobility.

An exemplary mobile radio communication system is a cellular communication system. The network infrastructures of various types of cellular communication systems have been deployed to encompass significant portions of the populated parts of the world. While cellular communication systems were first used primarily for the effectuation of voice communications, increasingly, new-generation, cellular communication systems are used to effectuate increasingly data-intensive communication services. Communications in a cellular communication system are typically carried out through use of a mobile station, a portable radio transceiver that operates to communicate with network devices of the communication system.

Additional mobile radio communication systems are undergoing development and deployment that exhibit characteristics analogous to cellular communication systems. Amongst such other radio communication systems are wireless local area networks (WLANs). A typical wireless local area network includes a network infrastructure including one or more fixed-site transceivers, referred to as access points (APs). A mobile station operable in the network communicates with an access point in whose coverage range that the mobile station is positioned.

A wireless local area network operates in conformity with a communication standard, such as a variant of the IEEE 802.11 series of standards, e.g., the IEEE 802.11n standard. A wireless local area network system is defined in terms of logical layers, and the aforementioned IEEE 802.11 standards include operating specifications related to different ones of the logical layers, such as a Medium Access Control (MAC) layer. Other communication systems are also generally defined in terms of logical layers, some also including a MAC layer, or its equivalent.

At the MAC layer, data that is to be communicated is formatted into data packets that include a header part and a payload part. A packet is referred to as a frame, and such terms shall be used interchangeably herein. Once the data is formatted into the packets, i.e., is packetized, the packets are caused to be communicated upon a radio channel for delivery to a desired destination at which the values contained in the packet are ascertained and the informational content of the communicated data is recovered. As presently promulgated, a variant of the IEEE 802.11 operating specification pursuant to which WLAN systems are typically constructed to be in conformity provides a positive acknowledgement scheme. That is to say, when a packet is delivered to a receiving station, i.e., the destination station, and the packet is successfully decoded, an acknowledgement is returned to the sending station to acknowledge the successful delivery of the packet to the receiving station.

If the sending station does not receive a positive acknowledgement, the sending station resends the packet, again for delivery to the receiving station. Retransmission of the original packet, without modification, is carried out, absent a positive acknowledgement, up to a retry limit.

Retransmission of the packet is not made immediately when a positive acknowledgement scheme is utilized. The sending station first awaits delivery of the acknowledgement for a time period. Subsequent to expiration of the time period, additional delays are introduced as the sending station utilizes a back off protocol when resending the packet. The back off procedure is used, e.g., to reduce the possibility of packet collisions of concurrently-transmitted packets by different communication stations that share a channel. The back off scheme utilizes a back off counter that is statistically biased to give preference to communication stations that have fewer previous transmissions. That is to say, communication stations that request their first packet retransmission have lower statistical priority for obtaining the medium, i.e., access to retransmit the packet, than communication stations that have not gained access to the medium for their first transmission.

If a hybrid acknowledgement scheme could be provided, communication delays would be reduced as the sending station would be earlier notified if a packet delivered to the destination station is unable successfully to be decoded at the destination station.

What is needed, therefore, is an improved acknowledgement scheme for MAC-layer packet communications in an IEEE 802.11 communication scheme.

It is in light of this background information related to communications in a radio communication system that the significant improvements of the present invention have evolved.

### SUMMARY

The present invention, accordingly, advantageously provides apparatus, and an associated method, that provides an automatic repeat request (ARQ) scheme for a packet radio, or other, communication system, such as a wireless local area network system operable pursuant to a variant of an IEEE 802.11 operating protocol, or other carrier sense multiple access system.

Through operation of an embodiment of the present invention, a hybrid automatic repeat request is provided for a carrier sense multiple access system, such as at the MAC layer of an IEEE 802.11-compliant WLAN system.

When the hybrid automatic repeat request scheme is implemented in a communication system, system performance and robustness is improved. The sending station at which a packet originates is notified of failure of successful delivery of the packet to the destination station, and the sending station performs retransmission operations earlier than would otherwise be permitted when only a positive acknowledgement scheme is utilized.

In one aspect of the present invention, a destination station to which a packet is to be delivered operates to detect a received sequence representative of the transmitted data packet. Detection is made of whether the received sequence includes selected values, first in the header part and then in the payload part. If the detection of the selected values is successful, then the packet has successfully been delivered to the destination station, and an acknowledgement is returned to the sending station to acknowledge the successful delivery to the destination station of the packet. If, conversely, the selected values are not detected, a negative acknowledgment is instead formed and returned to the sending station to indicate the failure of the detection of the selected values. If the selected values of the header part are unable to be ascertained correctly within a designated time period, a negative acknowledgement is returned to the sending station. And, if the selected values of the payload part are unable correctly to be ascertained, the negative acknowledgement is also generated and returned to the sending station.

The selected values of the header part of the packet include, for instance, the preamble part of the packet, the physical (PHY) header part of the packet, and the MAC header part of the packet. If any of these header parts are unable to be detected at the destination station correctly, and a selected time period has expired, a negative acknowledgement is sent to the sending station. The data packet is, for instance, coded at the sending station prior to its communication to the destination station, and the packet includes, for instance, a cyclic redundancy code (CRC). If the destination station is unable to detect the CRC values, a negative acknowledgement is caused to be generated by the destination station for return to the sending station.

The sending station detects the message, whether a positive acknowledgement or a negative acknowledgement, that is returned by the destination station to the sending station.

The negative acknowledgement message forms, for instance, a negative acknowledgment (NACK) frame that is formatted into fields or frame parts, of which various of the fields are populated with values for different purposes. The negative acknowledgement identifies unsuccessful decoding of a packet earlier-communicated by the sending station to the destination station. When the negative acknowledgement is received at the transmitting station, its contents are detected, and selection is made of a manner by which to respond to the negative acknowledgement.

When the packet is coded to include systematic bits and parity bits, the systematic bits, i.e., information bits, of the packet and, selectably, a portion of the parity bits are initially sent for delivery to the destination station. If the destination station successfully decodes the packet, a positive acknowledgement is returned to the sending station. When the sending station receives a positive acknowledgement, the earlier-transmitted packet, together with any unsent parity bits, are discarded. And, communication operations continue with the communication of subsequent packets. If the negative acknowledgement is returned to the sending station, an additional group of parity bits are caused to be sent by the sending station for delivery to the destination station. Through this incremental redundancy of the transmitted data, the destination station again attempts to decode the transmitted packet in which the additional group of parity bits are used to augment the earlier-received data. Alternately, selection is made at the sending station to resend the already-sent data. When the already-sent data is resent and delivered to the destination station, the destination station performs soft combining operations to attempt to decode the packet. Also alternately, selection of both incremental redundancy and soft combining techniques are together selected to be utilized concurrently.

As the use of a hybrid automatic repeat request scheme is utilized at the MAC layer, unsuccessful decoding of a packet at a receiving station is made known to the sending station, thereby permitting the sending station more quickly to take additional action to facilitate effectuation of the communication of the data to the receiving station.

In these and other aspects, therefore, apparatus, and an associated method, is provided for facilitating operation of a communication station pursuant to communication of a Medium Access Control (MAC) layer Data Unit. A packet detector is adapted to detect a received sequence delivered to the communication station. The received sequence is formed, prior to communication to the communication station, of the Medium Access Control layer Data Unit. Detection made by the packet detector is of whether the received sequence contains a header part of selected values. An acknowledgement message generator is operable responsive to the detection made by the detector. The acknowledgment message generator generates an acknowledgment message. The acknowledgement message forms a negative acknowledgment to indicate failure of detection by the detector of the header part of the selected values.

In these and other aspects, apparatus, and an associated method, is also provided for facilitating operation of a communication station pursuant to communication of a Medium Access Control (MAC) layer Data Unit. An acknowledgement message detector is adapted to receive an indication of whether an earlier-transmitted MAC layer Data Unit was successfully communicated. The indication received by the acknowledgement message detector is of a first value to indicate successful delivery of the earlier-transmitted MAC layer Data Unit and of a second value to indicate unsuccessful delivery of the earlier-transmitted MAC layer Data Unit. An MAC layer operation selector is operable responsive to detection made by the acknowledgement message detector. Operation is selected by the MAC layer operation selector to send at least part of the earlier-transmitted MAC layer Data Unit when the indication by the acknowledgement message detector comprises the second value.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a packet communication system in which an embodiment of the present invention is operable.

FIG. 2 illustrates a graphical representation of counter values of random back off counters conventionally used in a positive acknowledgement communication scheme together with indications of negative acknowledgements generated pursuant to a hybrid automatic repeat request scheme pursuant to an embodiment of the present invention.

FIG. 3 illustrates a timing diagram that represents exemplary operation of the communication system shown in FIG. 1 pursuant to operation of an embodiment of the present invention.

FIG. 4 illustrates the frame format of the hybrid automatic repeat request scheme of an embodiment of the present invention.

FIG. 5 illustrates the format of a negative acknowledgement control frame formed pursuant to operation of an embodiment of the present invention.

FIG. 6 illustrates a flow chart representative of exemplary operation of an embodiment of the present invention.

FIG. 7 illustrates a flow chart, also representative of exemplary operation of an embodiment of the present invention.

### DETAILED DESCRIPTION

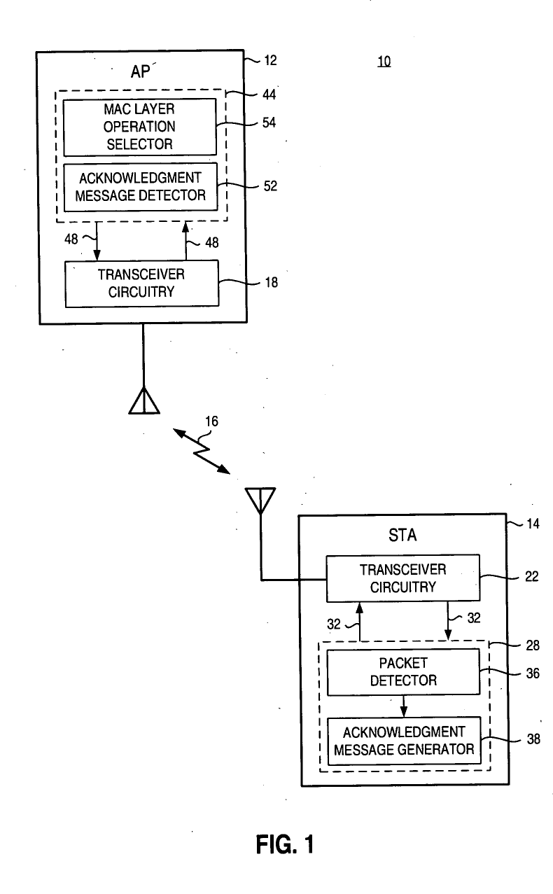

Referring first to FIG. 1, a radio communication system, shown generally at 10, provides for the communication of data between a set of communication stations, here including communication station 12 and communication station 14. in the exemplary implementation shown in the Figure, the communication system forms a wireless local area network (WLAN) system that includes a network part of which the communication station 12 forms a portion. The communication station 12 forms part of the network portion of the communication system is an access point (AP), a fixed-site, radio transceiver. And, the communication station 14 here forms a mobile station (STA) that is capable of communicating with the access point when the mobile station is within the coverage area of the access point. Data is communicated between the access point and the mobile station by way of radio channels defined upon a radio link 16.

The communication system 10, in the exemplary implementation, is operable in general conformity with the operating protocols of a variant of the IEEE 802.11 family of standards, here, in particular, the IEEE 802.11n standard. Two-way communications between the access point and the mobile station are generally provided. As set forth in the operating specification pursuant to which the communication system in operable, the data is formatted into data packets prior to its communication. And, the packets are further encoded prior to their communication and decoded subsequent to their delivery. While the communication stations 12 and 14 are each capable generally of two-way communications, for purposes of explanation of an embodiment of the present invention, operation shall be described with respect to communication of a data packet originated a the access point 12 and communicated upon a radio channel for delivery to the mobile station 14. That is to say, as described herein, the access point forming the communication station 12 acts as a sending station, and the mobile station forming the communication station 14 acts as a destination station. Analogous operation in which a data packet originated at the mobile station and communicated to the access point can be analogously described.

Data that is to be communicated by the access point to the mobile station is formatted into a MAC-layer (Medium Access Control-layer) packet having a header part and a payload part. The packet is further encoded into encoded form to facilitate its successful communication upon a channel susceptible to distortion, such as fading conditions. Once the MAC-layer packet is formed, the packet is provided to a physical layer, here represented by a transceiver 18, of the access point from which the packet is caused to be transmitted upon a radio channel, e.g., spread across subcarriers defined in the communication system, for delivery to the mobile station.

The mobile station includes a transceiver 22 that includes a receive part for receiving signal energy delivered to the mobile station.

As noted previously, in conventional operation, a positive acknowledgement scheme is utilized by way of which to acknowledge successful delivery of a MAC-layer packet at the destination station, here, for purposes of example, the mobile station. When the packet is not successfully delivered to a destination station in which a positive acknowledgement scheme is utilized, the sending station, here the access point, is only made aware of the failed communication for the reason that no positive acknowledgement is returned to the sending station. Communication delays result as the sending station delays for a period in the resending of the packet while awaiting the positive acknowledgement reply. And, when retransmitting the packet, a back off scheme is utilized.

An embodiment of the present invention provides a manner by which to notify the sending station of failed recovery of a packet through the generation and return of a negative acknowledgement (NACK). In accordance with an embodiment of the present invention, therefore, the destination station includes apparatus 28 of an embodiment of the present invention. Again, for purposes of illustration, the mobile station 14 forms the destination station; when the access point forms a destination station, as is typical in a two-way communication system, the access point also includes an apparatus 28. The apparatus 28 is formed of functional entities, implementable in any desired manner, such as by hardware, software, or combinations thereof, implementations. The apparatus 28 is coupled to the transceiver circuitry 22 by way of the lines 32. In one implementation, the apparatus 28 is embodied together with the transceiver circuitry 22 and forms a portion thereof.

The apparatus includes a packet detector 36 that detects delivery of a MAC-layer packet at the transceiver circuitry 22. The detector operates to detect whether the signal energy of the packet has been successfully decoded, e.g., to identify whether a header part of the packet is detected and, e.g., to identify whether the payload part of the packet appears to be decodable, such as through identification of a cyclic redundancy code formed of parts of the packet.

Responsive to detections made by the packet detector 36, an acknowledgement message generator generates an acknowledgment message for return by the destination station to the sending station. When the packet detector is able to detect the successful decoding or other recovery of the received packet, a positive acknowledgment is caused to be generated by the acknowledge message generator causes generation of a negative acknowledgement for return to the sending station to inform the sending station of the unsuccessful decoding or other recovery of the data packet.

The acknowledgement message generated at the destination station and returned to the sending station, here formed of the access point 12 is detected by the receive part of the transceiver circuitry 18.

The sending station includes further apparatus 44 of an embodiment of the present invention. The apparatus 44 is also functionally represented, formed of functional entities implementable in any desired manner, including hardware implementation, software implementation, and combinations thereof. Again, for purposes of illustration, the access point is here shown to form the sending station. In an actual implementation in which two-way communications are carried out, the mobile station also includes the functionality of the apparatus 44. The apparatus 44 is coupled to the transceiver circuitry 18, hereby way of the lines 48. In one implementation, the apparatus 44 is embodied at, and forms a portion of, the transceiver circuitry.

The apparatus 44 here includes an acknowledgement message detector 52 that operates to detect delivery at the sending station of the acknowledgement message generated by the destination station. The acknowledgement message is either a positive acknowledgement (ACK) message or a negative acknowledgment (NACK) message that indicates, respectively, successful or unsuccessful delivery and decoding of the earlier-transmitted packet.

The apparatus 44 further includes a MAC layer operation selector 54 that operates responsive to detection made by the detector 52. The selector selects further operation of the sending station with respect to the earlier-transmitted packet. If a positive acknowledgement is detected by the detector, the earlier-transmitted packet has been successfully delivered to the destination station. And, the selector 54 selects to discard the earlier-transmitted packet as its retransmission is not necessitated. If, conversely, a negative acknowledgement is returned, the selector selects whether, and in what manner to resend information associated with the earlier-transmitted packet. In one implementation, an incremental redundancy scheme is utilized. And, in another implementation, a soft combining scheme is utilized. And in another implementation, a combination of both incremental redundancy and soft combining schemes are utilized.

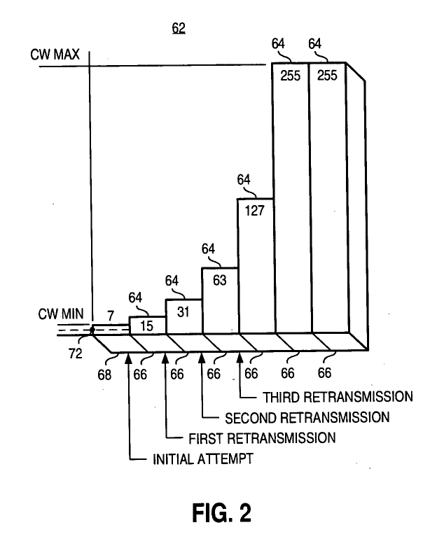

When the selection is made to perform incremental redundancy, retransmission includes transmission of a group of parity bits associated with the earlier-transmitted packet. The additional parity bits, when delivered to the destination station are used in a subsequent decoding attempt to decode the packet. If soft combining is utilized, retransmission of the earlier-transmitted data is selected to be carried out. When the retransmitted data is delivered to the destination station, the retransmitted data is combined with the earlier-transmitted data and decoding of the data is again attempted. Combinations of both the incremental redundancy and soft combining operations, either sequentially or together are carried out. For instance, responsive to a first negative acknowledgement, selection is made of use of incremental redundancy in the subsequent transmission. And, if a selected number of failed transmissions results, a soft combining scheme is carried out. Other combinations are correspondingly selectable. FIG. 2 illustrates a graphical representation, shown generally at 62. The graphical representation illustrates a plurality of bars 64, each identifying back off counter values that are determinative of packet retransmissions pursuant to conventional practice. Here, multiple retransmissions 66 are carried out subsequent to an initial attempt 68 to communicate the data packet to a destination station. Here, the back off counter maximum is a count value of 255. When a positive acknowledgement scheme is utilized, retransmission attempts are carried out up to a retry limit.

When a hybrid automatic repeat request scheme (H-ARQ), provided pursuant to operation of an embodiment of the present invention, is utilized, the retransmissions are carried out responsive to detection of a negative acknowledgement and not the expiration of a back off counter value expiration. For instance, if a negative acknowledgement is received at a time corresponding to a back off counter value of four, indicated in FIG. 2 at the point 72, retransmission, or other operation, is earlier carried out. Communication delays are less likely to occur, facilitating improved communication operations through use of the hybrid automatic repeat request scheme used pursuant to an embodiment of the present invention.

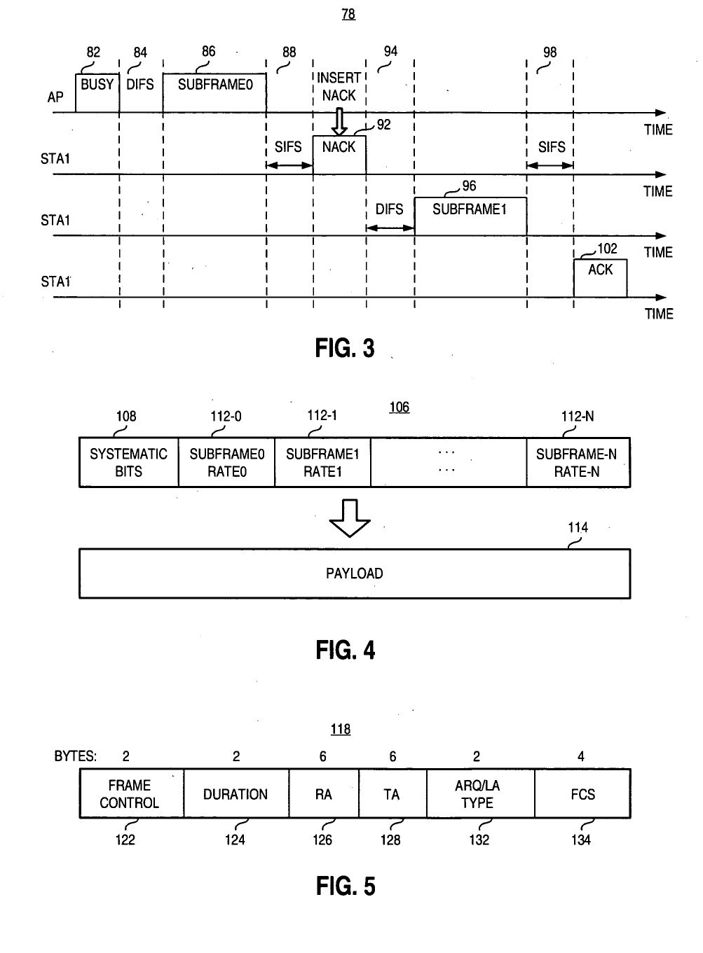

FIG. 3 illustrates a timing diagram, shown generally at 78, representative of exemplary operation of the communication system 10 pursuant to an embodiment of the present invention. Again, the access point 12 forms the sending station and mobile stations 14 form the destination stations. Data transmission commences subsequent to a busy period 82 and a DIFS (Distributed Control Function Inter Frame Space). A first subframe 86 is communicated by the sending station for delivery to the mobile station 14-1. Subsequent to a short inter frame space (SIFS) 88, a negative (NACK) 92 is generated at the mobile station due to unsuccessful decoding of the subframe. The negative acknowledgement is returned by the mobile station 14-1 to the access point and, as noted previously, subsequent action is taken at the access point responsive to detection of the negative acknowledgement.

Here, subsequent to another DIFS (DCF Inter Frame Space) 94, a subsequent transmission 96 is sent to the mobile station. Here, the mobile station is able to decode the packet and, subsequent to an SIFS interval 98, an acknowledgement (ACK) 102 is generated and returned to the access point.

FIG. 4 illustrates the frame format, shown generally at 106, used pursuant to an embodiment of the present invention, represented, for instance, in the timing diagram 78 shown in FIG. 3. Here, the frame includes systematic bits 108, and n subframes 112, here subframes 112-0 though 112-n. The payload 114 is selectably included as part of the subframe portions.

FIG. 5 illustrates the format of a negative acknowledgement (NACK) message 118 generated during operation of an embodiment of the present invention if the destination is unable correctly to decode a received packet. The frame includes a plurality of fields, including a frame control field 122, a duration field 124, an RA field 126, a TA field 128, an ARQ/LA type field 132, and an FCS field 134. The frame control field is populated with values corresponding to those set forth in the IEEE 802.11 operating specification pertaining to the MAC layer. The negative acknowledgement message, in other implementations, is formatted in different manners and includes different types of information, used to alert the sending station of unsatisfactory recovery of the informational content of the transmitted data.

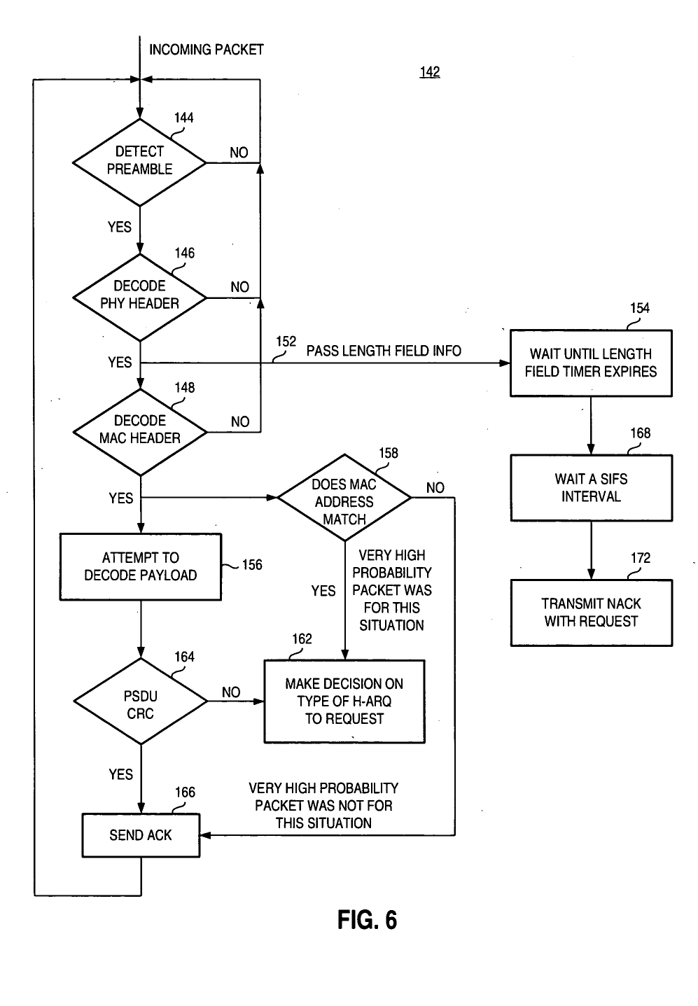

FIG. 6 illustrates a flow diagram, shown generally at 142, representative of operation of an embodiment of the present invention at a destination station, such as the mobile station 12 shown in FIG. 1. An incoming packet is delivered at the destination station and operations are performed on the delivered packet, first to detect, here indicated by the decision block 144 whether a preamble part of a received message is detected. If not, the no branch is taken back to the decision block. If, however, the preamble is detected, the yes branch is taken to the decision block 146 and a determination is made whether the physical (PHY) header of the message is decodable. If not, the no branch is taken back to the decision block 144. If, the header is detected, the yes branch is taken to the decision block 148. And, also, length field information is passed, indicated by the line 152, and a length field timer times, indicated by the block 154.

A determination is made at the decision block 148 as to whether a MAC-layer header part of the message is decodable. If not, the no branch is taken back to the decision block 144. If, conversely, the MAC-layer header is decodable, i.e., ascertainable, the yes branch is taken to the block 156 and to the decision block 158. At the block 156, an attempt is made to decode the payload part of the message. And, at the decision block 158, a determination is made as to whether the MAC-layer address has a match. If so, the yes branch is taken to the block 162, and a decision is made as to the type of response message, i.e., a positive acknowledgement or a negative acknowledgement that is to be returned to the sending station.

Subsequent to the attempt to decode the payload at the block 156, a determination is made at the decision block 164 as to whether the packet service data unit (PSDU) CRC (Cyclic Redundancy Code) is determinable. If not, the no branch is taken to the block 162. Otherwise, the yes branch is taken to the block 166, and an acknowledgement message is sent to acknowledge successful delivery of the packet to the destination station. A path is taken back to the decision block 144 awaiting delivery of a subsequent packet. When the no branch is taken by the decision block 164 to the block 162, the decision made at the block 162 is, e.g., to send a negative acknowledgement message for return to the sending station. As indicated by the blocks 168 and 172, subsequent to expiration of a length field timer and an SIFS interval, the negative acknowledgment message is transmitted, for return to the sending station.

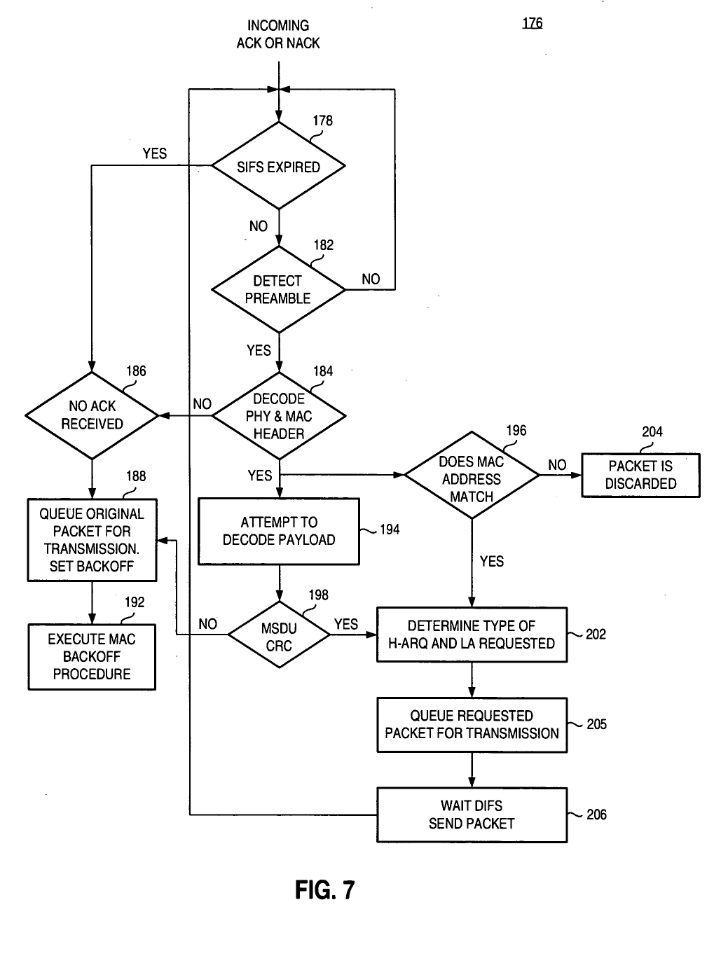

FIG. 7 illustrates a flow diagram, shown generally at 176, representative of exemplary operation of an embodiment of the present invention at a sending station, such as the access point 12 shown in FIG. 1, to which an acknowledgement message generated pursuant to a MAC-layer hybrid automatic repeat request scheme is delivered. An incoming acknowledgement or negative acknowledgement is delivered to the sending station, and, a determination is first made at the decision block 178 as to whether a SIFS (Short Inter Frame Space) period has expired. If not, the no branch is taken to the decision block 182, and detection is attempted of a preamble part of the incoming message. If the preamble part can not be detected, the no branch is taken back to the decision block 178. If, conversely, the preamble is detected, the yes branch is taken to the decision block 184.

If, at the decision block 178, the SIFS period has expired, the yes branch is taken to the decision block 186, and a determination is made if no acknowledgment has been received. If so, a branch is taken to the block 188, and the original packet, that is, the earlier-transmitted packet, is cued for retransmission and a back off timer is commenced. Thereafter, and as indicated by the block 192, retransmission is effectuated pursuant to execution of the MAC-layer back off procedure.

At the decision block 184, a determination is made as to whether the physical and MAC-layer header parts are decoded. If not, the no branch is taken to the decision block 186. If, however, the header parts are decodable, the yes branch is taken to the blocks 194 and 196. At the block 194, an attempt is made to decode the payload part of the received message. And, thereafter, and as indicated by the decision block 198, a determination is made as to whether the MSDUCRC is decodable. If not, the no branch is taken to the block 188. If the CRC is determinable, the yes branch is taken to the block 202.

At the decision block 196, a determination is made as to whether the MAC-layer address is a match. If not, the no branch is taken to the block 204, and the packet is discarded. Otherwise, the yes branch is taken to the block 202.

At the block 202, a determination is made of the type of automatic repeat request and link adaptation is requested. Thereafter, and as indicated at the block 204, the requested packet, or part thereof, is cued for transmission. And, as indicated by the block 206, subsequent to expiration of the DIFS period, the packet is sent.

Thereby, a hybrid-ARQ scheme is provided at the medium access control layer of an IEEE 802.11n-compliant wireless local area network system, or other Carrier Sense Multiple Access (CSMA/CA) communication system. Improved communication performance is provided as communication delays that are sometimes otherwise associated in only a positive acknowledgement scheme are avoided.

The previous descriptions are of preferred examples for implementing the invention, and the scope of the invention should not necessarily be limited by this description. The scope of the present invention is defined by the following claims.

1. Apparatus for facilitating operation of a communication station pursuant to communication of a Medium Access Control (MAC) layer Data Unit, said apparatus comprising:
a packet detector adapted to detect a received sequence delivered to the communication station, the received sequence formed, prior to communication to the communication station, of the Medium Access Control layer Data Unit, detection made by said packet detector of whether the received sequence contains a header part of selected values; and
an acknowledgement message generator operable responsive to the detection made by said detector to generate an acknowledgement message, the acknowledgement message forming a negative acknowledgement to indicate failure of detection by said detector of the header part of the selected values.

2. The apparatus of claim 1 wherein the acknowledgement message generator further forms a positive acknowledgement to indicate successful detection by said detector of the header part.

3. The apparatus of claim 2 wherein the communication station operates pursuant to a Carrier Sense Multiple Access communication scheme and wherein the negative acknowledgement and the positive acknowledgement formed by said acknowledgement message generator define a hybrid Automatic Repeat Request scheme.

4. The apparatus of claim 1 wherein the negative acknowledgement formed of the acknowledgment message generated by said acknowledgement message generator comprises a negative acknowledgement control frame.

5. The apparatus of claim 4 wherein the negative acknowledgement control frame is formatted into frame parts, the frame parts including a frame identifier that identifies the negative acknowledgment control frame.

6. The apparatus of claim 4 wherein the negative acknowledgment control frame is formatted into frame parts, the frame parts including a duration part that identifies a duration indicia.

7. The apparatus of claim 4 wherein the negative acknowledgement control frame is formatted into frame parts, the frame parts including a frame control part populated with IEEE 802.11 frame control field information.

8. The apparatus of claim 1 wherein the communication station comprises a mobile station and wherein said packet detector and said acknowledgement message generator are embodied at the mobile station.

9. The apparatus of claim 1 wherein the communication station comprises a fixed-site network station and wherein said packet detector and said acknowledgement message generator are embodied at the fixed-site network station.

10. The apparatus of claim 1 wherein the Medium Access Control layer Data Unit comprises a coded Medium Access Control layer Data Unit and wherein said packet detector further decodes the received sequence.

11. The apparatus of claim 10 wherein the coded Medium Access Control layer Data Unit comprises a cyclic redundancy code part and wherein said packet detector detects whether the received sequence contains the cyclic redundancy code.

12. The apparatus of claim 11 wherein the coded Medium Access Contol layer Data Unit comprises a header part, a cyclic redundancy code part, and a payload part, detection made by said packet detector first of the header part and then of the cyclic redundancy code part.

13. Apparatus for facilitating operation of a communication station pursuant to communication of a Medium Access Control (MAC) layer Data Unit, said apparatus comprising:
an acknowledgment message detector adapted to receive an indication of whether an earlier-transmitted MAC layer Data Unit was successfully communicated, the indication received by said acknowledgement message detector of a first value to indicate successful delivery of the earlier-transmitted MAC layer Data Unit and of a second value to indicate unsuccessful delivery of the earlier-transmitted MAC layer Data Unit; and
a MAC layer operation selector operable responsive to detection made by said acknowledgment message detector, operation selected by said MAC layer operation selector to send at least part of the earlier-transmitted MAC layer Data Unit when the indication by said acknowledgment message detector comprises the second value.

14. The apparatus of claim 13 wherein the MAC layer Data Unit comprises a coded MAC layer Data Unit and wherein said MAC layer operation selector selects to send a coded part of the earlier-transmitted coded MAC layer Data Unit.

15. The apparatus of claim 14 wherein the coded part selected by said MAC layer operation selector is selected pursuant to an incremental redundancy scheme.

16. The apparatus of claim 14 wherein the coded part selected by said MAC layer operation selector is selected pursuant to a soft combining scheme.

17. A method for facilitating operation of a communication station pursuant to communication of a Medium Access Control (MAC) layer Data Unit, said method comprising the operations of:
detecting delivery of a received sequence to the communication station, the received sequence formed, prior to communication to the communication station, of a coded MAC layer Data Unit and whether the received sequence contains a header part of selected values; and
generating an acknowledgement message responsive thereto, the acknowledgement message forming a negative acknowledgement to indicate failure of detection during said operation of detecting of the header part of the selected values.

18. The method of claim 17 wherein the acknowledgment message formed during said operation of generating further comprises a positive acknowledgment to indicate successful detection during said operation of detecting of the header part of the selected values.

19. The method of claim 18 wherein the communication station operates pursuant to a Carrier Sense Multiple Access communication scheme and wherein the negative acknowledgement and the positive acknowledgement formed during said operation of generating defines a hybrid Automatic Repeat Request scheme.

20. The method of claim 17 wherein the acknowledgement message generated during said operation of generating comprises a negative acknowledgement frame, formatted into frame parts.
